(19) United States
(12) Patent Application Publication
(10) Pub. No.: US 2006/0095898 A1
(43) Pub. Date: May 4, 2006

(54) Method for integrating multiple object files from heterogeneous architectures into a set of files

(75) Inventors: Alex Chunghen Chow, Austin, TX (US); Michael Norman Day, Round Rock, TX (US); Michael Stan Gowen, Georgetown, TX (US); Keisuke Inoue, Kanagawa (JP); James Xenidis, Carmel, NY (US); Takayuki Uchikawa, Austin, TX (US)

Correspondence Address: IBM CORPORATION (CS);C/O CARR LLP, 670 FOUNDERS SQUARE, 900 JACKSON STREET, DALLAS, TX, 75202, US

(73) Assignees: International Business Machines Corporation, Armonk, NY (US); Sony Computer Entertainment Inc., Tokyo (JP); Toshiba America Electronic Components, Inc, Irvine, CA (US); Kabushiki Kaisha Toshiba, Tokyo (JP)

(21) Appl. No.: 10/976,264

(22) Filed: Oct. 28, 2004

(51) Int. Cl. G06F 9/45

(52) U.S. Cl. 717/140

(57) ABSTRACT

The present invention is a method for integrating multiple object codes from heterogeneous architectures. For a program on a first processor to reference a program from the name space of a second processor, the object code for the second-processor program is enclosed in a wrapper to create object code in the first-processor name space. The header of the wrapped object code defines a new symbol in the name space of the first processor, and the symbol points to the second-processor object code contained in the wrapped object code. Instead of directly referencing the second-processor object code, the referencing program on the first processor references the wrapped object code. A system tool can be used to wrap the object code which runs on the second processor.

### TECHNICAL FIELD

The present invention relates generally to the processing of object files and, more particularly, to the integrating of multiple object files from heterogeneous architectures.

### BACKGROUND

In a multiprocessor with separate name spaces corresponding to different processors, a program defined in one name space may reference a program defined on another name space. The processors involved may comprise different machine types, with different architectures, different instructions sets, and different forms of object files.

Traditional methods of resolving the references present problems. For example, a linker could misinterpret object code generated by another processor, and handle the code incorrectly. The programmer could hard code a call from a program running on one processor to a program in the name space of another processor, but the process could become cumbersome. With the hard coding, it would not be possible for runtime reference to the object code, for dynamic linking and object sharing, or for execution time handling of an object from the combined multiprocessor name space.

Therefore, there is a need for a method of integrating multiple object files from heterogeneous architectures so that system tools such as the linker and loader can properly handle the object files, and so that runtime reference to the object files, dynamic linking and object sharing, and execution time handling of objects from the combined multiprocessor name space are possible.

### SUMMARY OF THE INVENTION

The present invention is a method for integrating multiple object codes from heterogeneous architectures. For a program on a first processor to reference a program from the name space of a second processor, the object code for the second-processor program is enclosed in a wrapper to create object code in the first-processor name space. The header of the wrapped object code defines a new symbol in the name space of the first processor, and the symbol points to the second-processor object code contained in the wrapped object code. Instead of directly referencing the second-processor object code, the referencing program on the first processor references the wrapped object code.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 shows a block diagram of a multiprocessor comprising processors with distinct architectures;

FIG. 2 illustrates enclosing object code in ELF format in a wrapper;

FIG. 3 depicts a flow diagram of the execution of object code on one processor after a call from another processor; and

FIG. 4 depicts a flow diagram of the creation of a wrapped object containing object code.

### DETAILED DESCRIPTION

In the following discussion, numerous specific details are set forth to provide a thorough understanding of the present invention. However, it will be apparent to those skilled in the art that the present invention may be practiced without such specific details. In other instances, well known elements have been illustrated in schematic or block diagram form in order not to obscure the present invention in unnecessary detail.

It is further noted that, unless indicated otherwise, all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise.

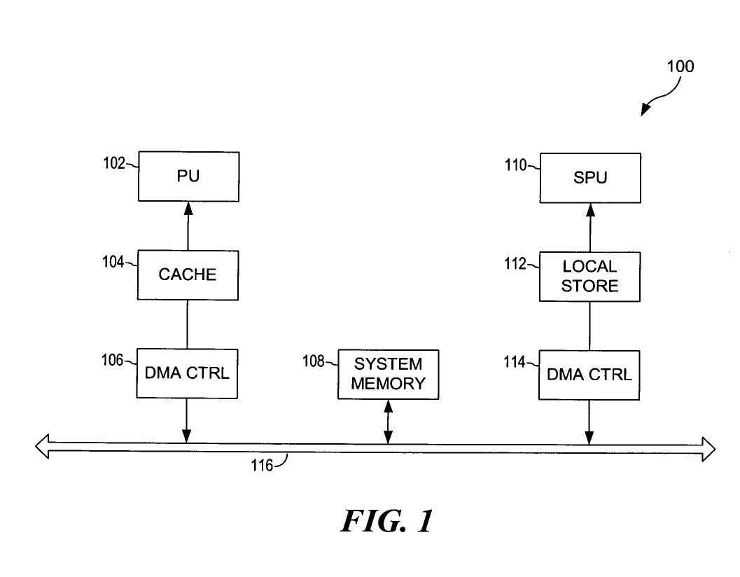

FIG. 1 shows a block diagram of a multiprocessor comprising processors with distinct architectures. The multiprocessor 100 comprises two processors, the PU 102 and the SPU 110, with heterogeneous architectures. Object files which run on one processor do not run on the other. Nevertheless, code running on the PU 102 may reference code designed to run on the SPU 110. The two processors, the PU 102 and the SPU 110 differ in their access to data. The PU 102 has access to system memory 108 and a cache 104, under the control of a first DMA controller 106. The DMA controller 106 handles load and store instructions to transfer data to and from the system memory 108 and the cache 104 and the PU 102. The data moving to and from the system memory 108 travels over a system bus 116.

The SPU 110 does not have access to the system memory 108 through load and store instructions. A second DMA controller 114 transfers data from the system memory 108 to local store 112, and the SPU 110 can load and store from there. The DMA controller 114 is connected to the system memory 108 via system bus 116.

In other embodiments of the invention, the architecture of the multiprocessor 100 is different. In an embodiment of the invention, the multiprocessor 100 comprises multiple copies of the PU 102, all sharing a single system memory. In an embodiment of the invention, the multiple copies of the PU 102 each share a single cache. In another embodiment, some groups of one or more PUs share a cache, while some PUs do not have access to a cache. In an embodiment of the invention, there are multiple copies of the SPUs. In an embodiment of the invention, the SPU 110 has its own separate memory.

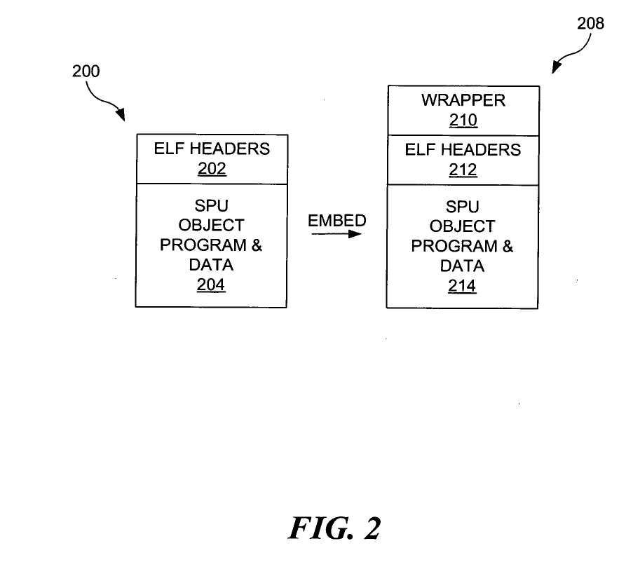

FIG. 2 illustrates enclosing object code in ELF format in a wrapper. Object code 200 in ELF format for an SPU 110 routine comprises an ELF header section 202 and the remaining sections of the object code 204 for the routine. The remaining sections include program and data. The object code 200 is converted into object code 208, which is a PU 102 object, by adding a wrapper 210. The wrapper 210 contains the symbol definition of a PU 102 object with the same name as the SPU 110 routine. For example, if the SPU 110 routine is BAR-SPU, the wrapper 210 defines a symbol BAR-SPU, a PU 102 object. The object code 208 also contains the object code 200, including the ELF headers 212 and the remaining sections of the object code 214. The symbol BAR-SPU is a pointer to, or refers to, the object code 200 within the object code 208. The SPU object code 200 is an SPU object, BAR-SPU.o, and the wrapped code 208 is a PU object, BAR-SPU-PU.o.

The wrapping process makes possible the integration of multiple object files from heterogeneous architectures. The wrapping of an SPU 110 object creates a PU 102 object which can be treated for linking and loading purposes as any other PU 102 object. During execution, the SPU 110 object that was wrapped is handled correctly. As a result, the wrapping process makes possible the integration of PU 102 and SPU 110 objects.

For example, to resolve a reference to the SPU 110 object BAR-SPU, the linker links to the PU 102 object BAR-SPU-PU.o. This method supports static and dynamic linking and the object sharing of an SPU 110 object. Similarly, the wrapping allows the loading of any SPU 110 file format. The wrapped PU object 208 is loaded. Further, PU 102 runtime reference can be made to an SPU 110 object. The runtime reference on the PU 102 is to the PU 102 object BAR-SPU-PU.

The wrapping also allows a clear separation of PU 102 object name space and SPU 110 object name space. Code running on the PU 102 does not have to refer directly to an SPU 110 object. Instead, the SPU 110 object is wrapped, creating a PU 102 object, and the PU 102 code refers to the wrapped object, a PU 102 object. The result is also a simple symbol association for PU 102 program reference. PU 102 code refers to a PU 102 symbol, which points to an SPU 110 object. The result gives the capability of pre-linking and mixing both PU 102 and SPU 110 objects. Finally, the wrapping process is friendly to library packaging for both static and dynamic needs.

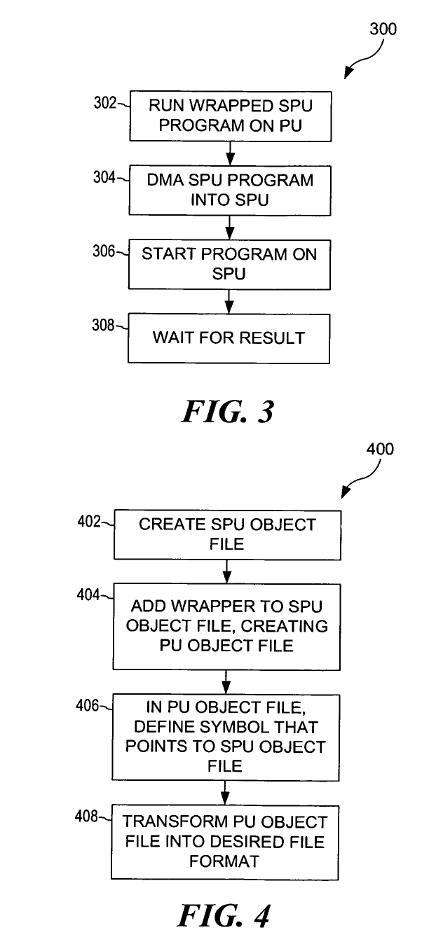

FIG. 3 depicts a flow diagram 300 of the execution of object code on one processor after a call from another processor. When a program FOO running on the PU 102 calls the routine BAR which runs on the SPU 110, the call to BAR is interpreted as a call to the PU 102 object BAR-SPU-PU.o. In step 302, the wrapped code BAR-SPU-PU.o is run on the PU 102. In step 304, the SPU object code for BAR, which is contained in the wrapped code BAR-SPU-PU.o, is then DMA'ed over to the local store 112 of the SPU 110. In step 306, the SPU 110 starts executing the code. When execution is complete, in step 308, the result is DMA'ed back to the PU 102.

FIG. 4 depicts a flow diagram 400 of the creation of a wrapped object containing SPU 110 object code. In an example, the SPU 110 routine is named BAR. In step 402, an SPU 110 object file is created for BAR in ELF format, BAR-SPU.o. This object file is created by a compiler or assembler compatible with the processor SPU 110. In step 404, a wrapper is placed on this code to create PU 102 object code, BAR-SPU-PU.o. In an embodiment, a system tool is available on the multiprocessor 100 to create the wrapper. In step 406, the system tool defines within the wrapper the PU 102 symbol BAR-SPU as a pointer to the SPU 110 object BAR-SPU.o, contained within the PU 102 object BAR-SPU-PU.o. Once the SPU 110 file has been embedded in a PU 102 object file, it can be treated as an ordinary PU 102 file, and in step 408, the user can transform it to any file format, such as an executable, dynamic shared library, and/or archive format.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A multiprocessor comprising:
a first processor; and
a second processor;
the multiprocessor configured for the generation of object code which runs on the first processor (OC1 code) corresponding to object code which runs on the second processor (OC2 code), the OC1 code containing the definition of a symbol which is a pointer to the OC2 code.

2. The multiprocessor of claim 1, further configured for the execution on the first processor of the OC1 code corresponding to OC2 code to cause the OC2 code to execute on the second processor.

3. The multiprocessor of claim 1, further comprising a system tool, the system tool configured to generate the OC1 code corresponding to OC2.

4. The multiprocessor of claim 1, further comprising a DMA controller, wherein the first processor comprises a system memory and the second processor comprises a local store, and wherein the multiprocessor is configured so that data is passed to the second processor by being loaded to the system memory of the first processor, and transferred by the DMA controller to the local store of the second processor.

5. The multiprocessor of claim 4, wherein OC1 code corresponding to OC2 code is generated by enclosing the OC2 code in a wrapper.

6. The multiprocessor of claim 5, further comprising a system tool configured to generate OC1 code corresponding to OC2 code by enclosing it in a wrapper.

7. The multiprocessor of claim 5, further configured so that the created OC1 code corresponding to OC2 code comprises:
a header section with a definition of a symbol; and
the OC2 code;
wherein the symbol is a pointer to the OC2 code.

8. A method for integrating multiple object files from heterogeneous architectures on a multiprocessor, the method comprising:
creating object code which runs on a first processor (OC1 code) with a pointer to object code which runs on the second processor (OC2 code); and
executing the created OC1 code on the first processor, thereby causing the executing of the OC2 code on the second processor.

9. The method of claim 8, wherein a system tool is provided to create the OC1 code.

10. The method of claim 8, wherein the created OC1 code contains the OC2 code.

11. The method of claim 10, wherein the created OC1 code comprises:
a header section with the definition of a symbol; and
the OC2 code;
and wherein the symbol is a pointer to the OC2 code contained in the created OC1 code.

12. The method of claim 10, further comprising the step of passing object code from the first processor to the second processor for execution.

13. The method of claim 8, further comprising the step of resolving a reference by OC1 code to the OC2 code as a reference to the created OC1 code.

14. The method of claim 8, further comprising the step of transforming the created OC1 code into an executable program.

15. The method of claim 8, further comprising the step of transforming the created OC1 code into an archive.

16. The method of claim 8, further comprising the step of transforming the created OC1 code into a dynamic shared library.

17. A computer program product for integrating multiple object files from heterogeneous architectures on a multiprocessor, the computer program product having a medium with a computer program embodied thereon, the computer program comprising:
computer code for creating object code which runs on a first processor (OC1 code), the created OC1 code containing a pointer to object code which runs on the second processor (OC2 code); and
computer code for executing the created OC1 code on the first processor, thereby causing the executing of the OC2 code on the second processor.

18. The computer program product of claim 17, wherein a system tool is provided to create the OC1 code.

19. The computer program product of claim 17, wherein the created OC1 code contains the OC2 code.

20. The computer program product of claim 19, wherein the created OC1 code comprises:
a header section with the definition of a symbol; and
the OC2 code;
and wherein the symbol is a pointer to the OC2 code contained in the created OC1 code.

21. The computer program product of claim 19, further comprising computer code for passing object code from the first processor to the second processor for execution.

22. The computer program product of claim 17, further comprising computer code for resolving a reference by OC1 code to the OC2 code as a reference to the created OC1 code.

23. The computer program product of claim 17, further comprising computer code for transforming the created OC1 code into an executable program.

24. The computer program product of claim 17, further comprising computer code for transforming the created OC1 code into an archive.

25. The computer program product of claim 17, further comprising computer code for transforming the created OC1 code into a dynamic shared library.
